(19) United States
(12) Patent Application Publication
(10) Pub. No.: US 2026/0084654 A1
(43) Pub. Date: Mar. 26, 2026

(54) Control of Access to a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/303,514

(22) Filed: Aug. 19, 2025

(30) Foreign Application Priority Data
Sep. 20, 2024 (DE) 10 2024 127 158.2

(51) Int. Cl. B60R 25/24; H04L 9/14

(52) U.S. Cl. CPC B60R 25/241; H04L 9/14; B60R 2325/202; B60R 2325/205

(57) ABSTRACT

A method for controlling access to a motor vehicle includes receiving an assignment ID relating to a mobile device and initiating an assignment procedure of a shared vehicle key for a user of the motor vehicle based on the received assignment ID, wherein the shared vehicle key is derived from a digital vehicle key for the motor vehicle.

This application claims priority under 35 U.S.C. § 119 from German Patent Application No. 10 2024 127 158.2, filed Sep. 20, 2024, the entire disclosure of which is herein expressly incorporated by reference.

### BACKGROUND AND SUMMARY

The invention relates to a technology for controlling access to a motor vehicle. The technology comprises, inter alia, initiating an assignment procedure of a shared vehicle key for a user of the motor vehicle, wherein the shared vehicle key is derived from a digital vehicle key for the motor vehicle.

A motor vehicle can be secured by means of a concept that was presented as the ‘Digital Car Key’ (DCK) by the ‘Car Connectivity Consortium’ (CCC). A comprehensive technical description can be found, e.g., in the technical specification ‘Digital Key Release 3’. The concept envisages controlling a security function of the vehicle, e.g., a central locking system and/or an immobilizer, based on an asymmetric cryptographic procedure. A digital vehicle key in the form of a cryptographic data structure can be assigned to a user. A wireless connection between a mobile device and the motor vehicle is used for authentication based on this key.

A digital vehicle key can comprise a private part and a public part. The private part can be stored in a secured environment of a mobile device. Conversely, a digital key is assigned to the vehicle, the private part of which can be stored in an on-board control unit. A public part is known by a user. To control a security or access function, two-sided authentication takes place based on the respective private and public key parts. If the authentication is successful, a requested security function on the vehicle is controlled, access to or use of the vehicle is enabled, etc.

A vehicle owner (“owner” according to CCC) has the option to share their key; the shared or derived key enables the user (“friend”, this can also be a service provider, e.g., a garage or an employee of the garage) to use the motor vehicle. The method for sharing the key may comprise, according to the CCC, sending a URL (‘Uniform Resource Locator’) to the user. The URL should then be called up on the device on which the derived key is to be stored.

Key sharing between natural persons can be based on personal trust between family members or the employees of a small enterprise. In a rather impersonal or even anonymous environment, the level of trust is not unlimited, such as when a driver hands over his vehicle to a member of a service provider, e.g., a garage, a parking service, etc. However, with the increasing spread of digital vehicle keys, there is a need for concepts to enable trustworthy key sharing.

A particular problem here is the URL that is sent to the mobile device of the service provider or other user for sharing the key: calling it up inevitably initiates the key assignment procedure, but the URL can in principle be called up not only on the mobile device intended for this purpose, but on any device that is designed to store digital vehicle keys.

For example, the intended recipient of the assigned key can forward the URL to another device, an unauthorized user, etc., and/or the URL can be intercepted and misused by a malicious party. There is a need to prevent such misuse by means of technical measures.

An underlying task of the present invention consists in providing an improved concept for a technology for controlling access to a motor vehicle. The invention solves this task by means of the objects of the independent claims. Subclaims represent preferred embodiments.

A first aspect of the present invention relates to a method for controlling access to a motor vehicle. The method may be implemented on the user side, e.g., on a mobile device of a person who wants to share a key. The method includes receiving an assignment ID relating to a mobile device; and initiating an assignment procedure of a shared vehicle key for a user of the motor vehicle based on the received assignment ID, wherein the shared vehicle key is derived from a digital vehicle key for the motor vehicle.

A second aspect of the present invention relates to another method for controlling access to a motor vehicle. The method may also be implemented on the user side, for example, on a mobile device of a person who is to receive an assigned key. The method comprises receiving an assignment ID relating to a mobile device; and verifying the assignment ID relating to an indication of a user account of a user, a device ID relating to the mobile device and/or an indication of a manufacturer of the mobile device.

A third aspect of the present invention relates to yet another method for controlling access to a motor vehicle. The method may be implemented on the server side, e.g., in a backend for the motor vehicle. The method comprises receiving a request message containing a first assignment ID relating to a mobile device; sending a response message relating to a receipt of the request message; and, during an assignment procedure of a shared vehicle key for a user of the motor vehicle, wherein the shared vehicle key is derived from a digital vehicle key for the motor vehicle: receiving a second assignment ID, and verifying the second assignment ID based on the first assignment ID.

Embodiments of the invention provide a framework for technical measures to establish a trust basis between a vehicle owner or driver, and a key recipient such as a user, service provider etc., e.g., if there is no particularly strong personal or individual relationship of trust. Embodiments according to the invention enable a verification that the assigned vehicle key is actually stored on a designated mobile device as intended, or on a mobile device that is assigned to a designated user account, e.g., an account of a garage or an employee of the garage. As an additional security measure, it can also be verified that the assigned key is stored on a particular type, manufacturer, etc. of the device.

A “mobile device” herein is to be understood as a tablet or smartphone, a smartwatch, a smartband, smartring etc., however in general any device on which a digital vehicle key, an assigned vehicle key etc. can be stored, and which can be used for access to a motor vehicle, thus also a smartcard, or any other, including future device that has the required processor capacities, storage capacities, etc.

In some embodiments the assignment ID can be a date or a date element, which a name, token, an access authorization, etc. comprises. The assignment ID can, for example, be provided by a designated receiver device or by a server of a manufacturer of the designated receiver device.

In many embodiments of the first aspect of the invention, receiving the assignment ID comprises receiving a short ID, sending a request message containing the short ID, and receiving a first response message containing the assignment ID. Such a sequence enables a simplified application on the sharing mobile device if a user who wants to share their digital vehicle key, e.g., comprises a short ID that is easy for a person to understand and use, such as the name of the recipient, etc.

The short ID and/or the assignment ID can be received verbally, by email, text message, a messenger service, by push message, etc. The entry of the short ID on the device whose key is to be shared can cause the actual assignment ID to be obtained in interaction with a server of the manufacturer of the receiver device intended for assignment. However, such an interaction could also additionally or alternatively include the receiver device (and/or a server in a backend for the motor vehicle).

To initiate the assignment procedure the user can type in the short ID or the assignment ID, e.g., or enter this in accordance with “Copy & Paste”, by language command etc. into the sharing mobile device.

In certain embodiments, the assignment ID comprises an indication of a user account of the user to whom the derived key is to be assigned. The user account can be an account of the intended recipient with a manufacturer of the receiver mobile device, an account of a service provider, etc. The assignment ID can be anonymized so that it is not possible to draw conclusions about the person of the intended recipient, the specific user account, etc.

Additionally or alternatively, in many embodiments, the assignment ID can relate to a device ID of the intended receiver mobile device. Any information that clearly identifies the receiver device and cannot be changed regarding the receiver device can be used here, such as a serial number of a crypto processor or other secured element, which is to keep the assigned vehicle key. However, a credit card number or other payment information can also be consulted in anonymized form, which is stored in the secured element.

Additionally or alternatively, the assignment ID can relate to an indication of a manufacturer of the intended receiving mobile device. For example, the sharing user can easily determine a manufacturer from a visual view of the intended mobile device and select a corresponding indication via a menu on the sharing mobile device, which then constitutes the assignment ID or supplements this.

If one or many of the indicated pieces of information are represented in the assignment ID, corresponding verifications are possible as part of the assignment method, such as whether the device ID of the receiving device matches the corresponding representation in the assignment ID, whether the manufacturer of the receiving device matches the manufacturer according to assignment ID, or whether the user account of the receiving device matches the user account represented in the assignment ID.

It can thus be flexibly verified in various ways that the assigned key is actually stored on an intended mobile device, e.g., in a commercial use case in which the assigned key is to be stored on the professionally used mobile device of a competent garage employee or parking service provider, or that the assigned key is stored on a device of several devices, which are assigned to an account of an intended user, e.g., an account of a garage or a private account.

Verifying the manufacturer of the recipient device can provide additional security and trustworthiness, and at the same time this information can be made available in a technically simple way.

Some embodiments of methods of the first aspect according to the invention furthermore comprise sending a request message containing the assignment ID; receiving a second response message relating to a receipt of the request message; and initiating the assignment procedure based on the receipt of the second response message. With these embodiments, an interaction with a backend of the vehicle can be implemented, to which the assignment ID is given before the actual assignment procedure begins. The backend can then store the assignment ID last received from the intended receiving mobile device (or its backend). This makes it possible to carry out a verification in the vehicle backend based on the stored assignment ID in the further course of the method.

In many embodiments initiating the assignment procedure comprises providing an assignment reference, which represents the assignment ID. The assignment reference can be a link, pointer, URI (“Uniform Resource Indicator”) or a URL, in which the assignment ID is represented, e.g., in a way that is in conformity with the data protection regulations. The provision of such a conforming assignment ID can also comprise a related interaction with a server of a manufacturer of the receiving device. With these embodiments the intended method according to the invention fits into familiar key assignment procedures with a minimum of additional complexity.

In a few embodiments of methods of the second aspect according to the invention, the assignment ID can be received as part of the receipt of an assignment reference, which represents the assignment ID, wherein the assignment reference relates to an assignment procedure of a shared vehicle key for the user of the motor vehicle, and wherein the shared vehicle key is derived from a digital vehicle key for the motor vehicle. These embodiments enable simple verification of the receiving device early in the assignment procedure as to whether it is actually intended as a receiving device for the key to be assigned, or whether the received URL is intended for another device (or another user account), is to be called up on another device, etc. Further key assignment can be canceled if the assignment ID is verified negatively; e.g., a backend for the vehicle does not even need more in a further verification, which involves the further key assignment procedure, etc.

Some embodiments of the second aspect of the invention further comprise, after a positive verification of the assignment ID, initiating the further assignment procedure. For example, the intended receiver device can call up further data from a relay server based on the URL, implement an endpoint according to CCC etc. Initiating can comprise a generation of an endpoint certificate, which relates to the shared vehicle key. In some embodiments the certificate can comprise an indication of the assignment ID, e.g., in the form of an extension (e.g., “extension” according to X.509). This is a preferred design from a safety point of view. In another embodiment, e.g., one that is easier to implement however it is also conceivable that the endpoint certificate does not comprise the assignment ID.

In some embodiments of methods of the third aspect according to the invention, receiving the second assignment ID takes place as part of receiving an endpoint certificate relating to the shared vehicle key, wherein the certificate comprises an indication of the second assignment ID. In another embodiment, however, the assignment ID can also access the backend of the motor vehicle as part of a key tracking according to CCC.

In many embodiments of methods of the third aspect according to the invention the verifying relates to an indication of a user account of a user, a device ID relating to the mobile device and/or an indication of a manufacturer of the mobile device. As already outlined above, these verifications can be carried out individually or in combination with each other flexibly, i.e., depending on the application, to ensure confidence that the assigned key is actually stored on the intended user device, a device that is assigned to an intended user account, etc.

For example, various embodiments of methods according to the invention can be used for various applications. If it is intended only to ensure that the assigned key is stored on any device of an intended user under whose account is stored, verifying a device ID (and possibly a manufacturer ID) can be dispensed with. If only one malicious attack, e.g., a man-in-the-middle attack, is to be prevented, under circumstances verifying a manufacturer of the intended user device, and with such a limited verification, the effort required for data protection (e.g., when creating the assignment ID) is correspondingly low.

A further aspect of the present invention relates to a mobile device, which is designed for controlling access to a motor vehicle according to the method described herein. The mobile device can comprise a secured environment and/or a secured element for the storage of device keys and/or assigned vehicle keys. On the mobile device, a software, an application, etc. can be installed which allows the user to control a key assignment procedure on the device side, an upstream procedure for obtaining an assignment ID, sending the assignment to a backend, a verification procedure, etc.

Yet another aspect of the present invention relates to a server, e.g., in a backend for the vehicle, which is designed for controlling access on a motor vehicle according to one of the methods described herein. The server can also be several servers, a server landscape, etc. The server can be operated by a manufacturer of the vehicle (and/or by a manufacturer of the sharing and/or receiving mobile device). Software can be installed on the server that enables service-side and/or technical control of key management system, in particular, a key assignment procedure, a verifying method, etc.

Yet another aspect of the present invention relates to a system for controlling access to a motor vehicle. The system comprises the motor vehicle, a first mobile device described herein, on which the digital vehicle key to be shared is stored, in particular, a second mobile device described herein, which is provided, in particular, for storing the key to be assigned, and a backend server described herein. The vehicle may also be designed to store the assigned key.

The invention is now described in greater detail regarding the appended drawings in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system, and

FIG. 2A illustrates a flowchart of a first method,

FIG. 2B illustrates a flowchart of a second method,

FIG. 2C illustrates a flowchart of a third method, and

FIG. 3 illustrates a flowchart of a fourth method.

### DETAILED DESCRIPTION OF THE DRAWINGS

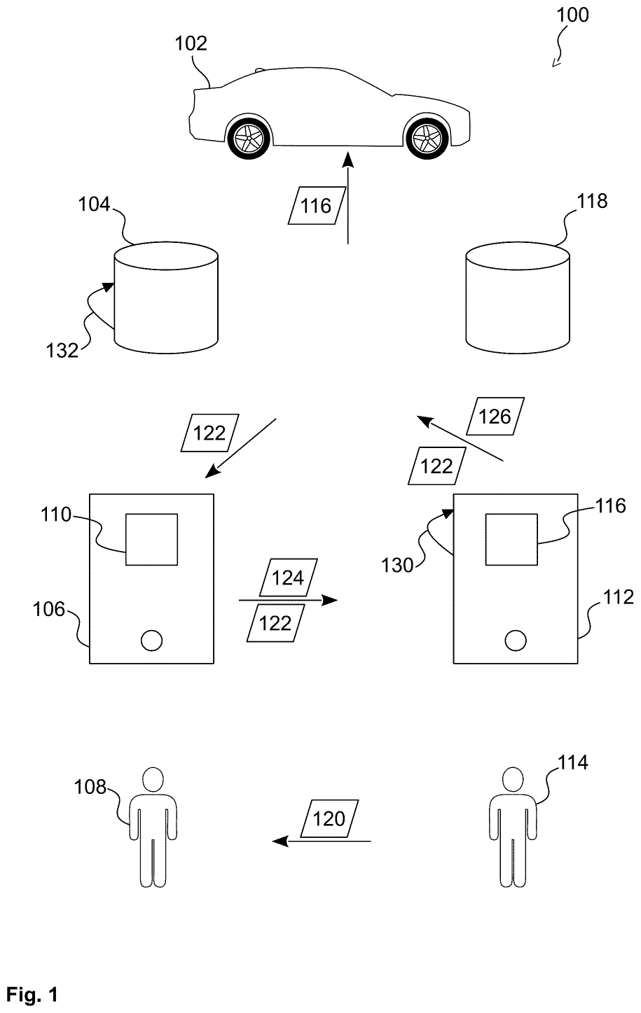

FIG. 1 shows in schematic form a system 100 with a motor vehicle 102, a server 104 in a backend for the vehicle 102, and a mobile device 106 of a user 108, who can be an owner (“owner” according to CCC) or driver of the vehicle 102, i.e., a digital vehicle key 110 for the vehicle 102 is stored on the mobile device 106. The system 100 further comprises a mobile device 112 of a user 114 to whom a derived vehicle key 116 for the vehicle 102 is to be assigned (‘friend’). A backend for the mobile device 110 is shown in the form of a server 118.

In the following, the reference symbol “104” is used both to generally designate a backend 104 or the backend 104 for the vehicle 102, and to specifically designate the server 104, which can be operated by a manufacturer of the vehicle 102. The server 104 may also be a plurality of interconnected servers, e.g., separate servers for a key management service, a technical key management service, etc.

In the same way the reference sign “118” is hereinafter used to refer to generally one or the backend 118 for the mobile device 112 as well as used to refer to the backend 118 for the mobile device 112 as well as used to refer specifically to the server 118. The server 118 can be operated by a manufacturer of the mobile device 112.

For the purposes of the assignment procedure upstream of the keys 116 to be assigned, the mobile device 104 is referred to below for the sake of clarity as the sharing, issuing, or sending mobile device 104, and the mobile device 112 is referred to as the intended, accepting or receiving mobile device 112.

The mobile device 106 has at least one secured environment or a secured element (not indicated in FIG. 1), in which there can be an HSM (“Hardware Security Module”), TPM (Trusted Platform Module”), a “Secure Enclave”, a TEE (“Trusted Execution Environment”) and/or a secured element (“Secure Element”), etc. In such a secured environment, the electronic, cryptographic, or digital vehicle key 110 can be stored.

The mobile device 112 also has at least one secured environment as described above. In this environment, the shared, assigned, or derived vehicle key 116 can be or become stored. Occasionally, for the sake of clarity, this does not refer to a “shared vehicle key” but in short form merely of a “shared key”.

A method for sharing a digital vehicle key, i.e., for setting up a derived vehicle key and storing the derived key on a mobile device of the (fellow) user, can be based on trust, e.g., personal acquaintance, family affiliation, affiliation with a small company, etc. However, technical measures are required to ensure that sharing a vehicle key is conceivable in other, less personal relationships to ensure that a shared key is actually stored on the intended mobile device (e.g., on a mobile device of an employee of a garage, a valet or parking service), or at least on a mobile device that is assigned to an intended user account (e.g., a user account of a garage or a valet parking service).

In the course of an assignment procedure (e.g., according to CCC) an intended user can contain a reference to a URL to their mobile device, e.g., in the form of a push message or notification (“Push Notification”). In principle, the user could forward this notification (and/or read out and forward the URL), and indeed, e.g., to the mobile device of another authorized user (e.g., of another garage employee) or however to another, own, private mobile device, or a mobile device of another, unauthorized user. In addition, the unsecured transmitted invitation notification could be forwarded or intercepted unnoticed or maliciously with the URL, by the sharing user.

According to the invention, technical precautions are proposed to ensure that (related to the scenario of FIG. 1) the key 116 to be assigned provides access to the vehicle 102 only to the authorized or intended user 114 (in the case of the user 114 could be several persons, e.g., the trustworthy employees of a garage). More specifically, it can be ensured according to the invention that, depending on the situation at hand or the specific application, the assigned key 114 is or will be stored either to a particular mobile device 112 of the user 114, or however the assigned key 114 is at least stored to a mobile device, which is assigned to a user account of the user 114. If a corresponding check or verification during key assignment is negative or fails, the key 116 is not activated and does not grant access rights to the vehicle 102.

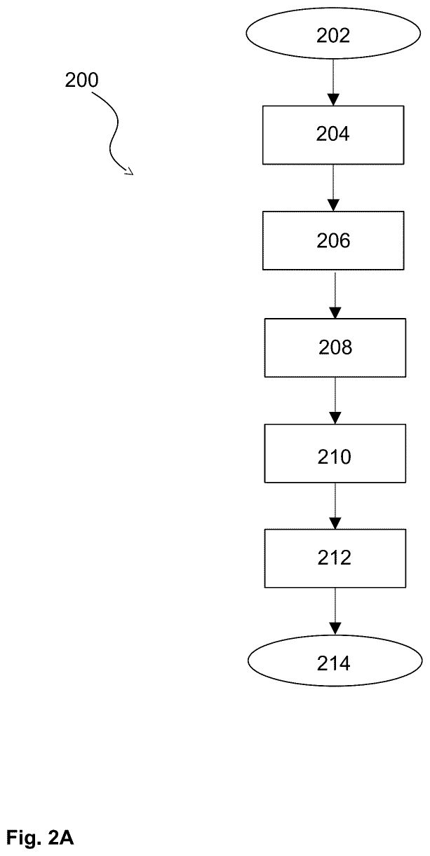

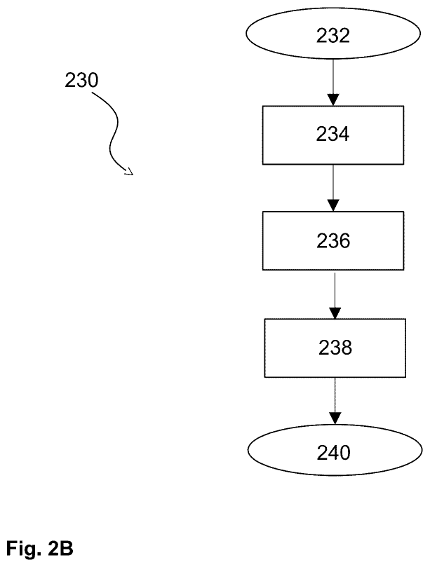

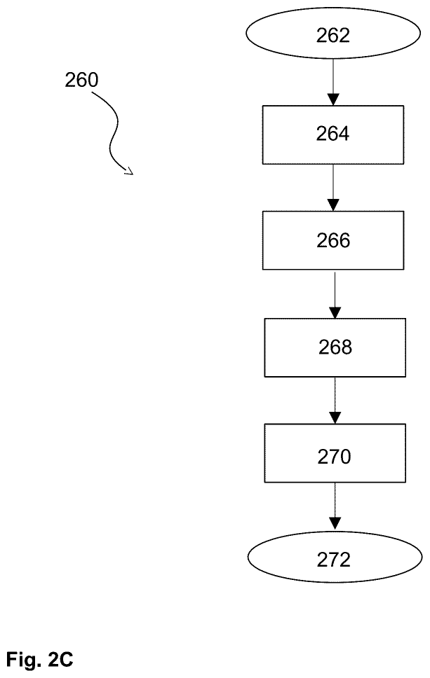

To achieve these effects, the components of the system 100 shown in FIG. 1 interact in an advantageous manner. An embodiment of a corresponding assignment method is described in more detail below with reference to the schematic diagrams shown in FIGS. 2A, 2B and 2C. Here, FIG. 2A shows a sequence of a method 200 for controlling access to the motor vehicle 102 in the mobile device 106. FIG. 2B shows a sequence of a corresponding method 230 in the mobile device 112. FIG. 2C shows a sequence of a corresponding method 260 in the backend 104 for the motor vehicle 102.

It should be noted that the method 200 from FIG. 2A can also be carried out in the mobile device 106 or in whole or in part in a backend for the mobile device 106; for reasons of clarity, however, this will not be discussed further below. The method 230 from FIG. 2B can also be carried out in the mobile device 112, but also in whole or in part in the backend 118 for the mobile device 112; for reasons of clarity however only those methods are described with reference to the device backend 118 that are of particular importance for understanding the invention.

Furthermore, it should be noted that any communication described below between the components shown in FIG. 1 can be based in each case on a connection or several connections on mobile radio basis and/or on wireless connections with short access, in which the vehicle 102 can serve as a relay station in a communication between mobile device 106 and the or one backend server 104, or the mobile device 112 can serve as a relay station in a communication between mobile device 106 and backend server 118. For reasons of clarity, this will also not be discussed further in the following description.

To achieve these effects, the components of the system 100 shown in FIG. 1 interact in an advantageous manner. An embodiment of a corresponding assignment method is described in more detail below with reference to the schematic diagrams shown in FIGS. 2A, 2B and 2C. The user 108 enters the received short ID in their mobile device 106. With that the method 200 is entered into FIG. 2A, namely with the receipt of the short ID 120 from mobile device 106 in Step 202.

In Step 204, the mobile device 106 sends a request message with the entered short ID to the backend 118 of the intended mobile device 112. The backend server 118 receives the request message, in response, provides an assignment ID 122 based on the received short ID 120, and sends the assignment ID 122 to the mobile device 106 in a response message.

In Step 206 the mobile device 106 receives the assignment ID 122. An illustrative example of an embodiment comprises the received assignment ID of a of a user account or profile of the user 114, as is contained on the server 118, e.g., a (anonymized) user ID number or ID, account ID, profile ID etc. Additionally or alternatively, the assignment ID 122 may comprise a device ID of the mobile device 112, which is unambiguous for the mobile device 112 (also e.g. important worldwide, or unambiguous for all mobile devices of a manufacturer of the mobile device 112, or is managed unambiguously for all devices that are managed by the server 118). The device ID can be based, e.g. on a serial number or ID, batch number, LOT number, etc. (or a combination of such numbers) of a crypto-processor or other secure environment of the mobile device 112.

In many embodiments, the assignment ID 122 can additionally or alternatively comprise an indication of manufacturer of the mobile device, an intended system. The backend server 118 receives the request message, provides an assignment ID 122 in response based on the received short ID 120, and sends the assignment ID 122 to the mobile device 106 in a response message.

The mobile device 106 notifies the assignment ID 122 in a procedure stored before the actual assignment method vehicle-backend 104. In detail, the mobile device 106 in Step 208 sends a corresponding request message with the assignment ID 122 to the server 104. Corresponding to this, the server 104 in Step 262 (method 260 in FIG. 2C) send the request message with the assignment ID 122 relating to the intended mobile device 112. The server 104 stores the assignment ID 122 in Step 264 for purposes of the later verification. In Step 264 the server 104 sends a response message relating to the successful receipt and the storage of the assignment ID to the mobile device 106.

This receives the response message in Step 210 (method 200 in FIG. 2A) and then initiates in Step 212 the actual assignment procedure for the vehicle key to be assigned 116. This can comprise a provision of a URL 124 in Step 214, wherein the assignment ID 122 is represented in the URL 124. In many embodiments the assignment ID is anonymized, i.e. allows no conclusions to be drawn about the user 114, mobile device 112, and/or a manufacturer of the mobile device 112. In other embodiments, this information is anonymized at the latest when the URL is created, i.e., the assignment ID is encoded into the URL in anonymized form.

The generated URL 124 is provided to the user 114 or their mobile device 112. This can e.g. be carried out in a private-to-private assignment scenario that the user 108 sends the link or the URL 124 to the user 114 by chat message, email etc. In other embodiments of a server-based assignment the server (e.g., in the backend 118) can send the URL 124 to the user 114, e.g., using a push message as transmission medium.

In Step 232 (method 230 in FIG. 2B) the mobile device 112 receives the URL with the received assignment ID. In other embodiments, this information is anonymized at the latest when the URL is generated, i.e., the assignment ID is encoded into the URL in anonymized form. In detail, in this regard, the indication of a user account according to the received URL 124 or assignment ID 122 is compared with an indication of a user account of the user 114, as it is known by the mobile device 112. Additionally or alternatively, a device ID according to the received URL 124 or assignment ID 122 is compared to a device ID, as it is known by the mobile device 112. Additionally or alternatively, a manufacturer ID of the received URL 124 or assignment ID 122 is compared with an indication such as a manufacturer ID of the mobile device hardware 112 (relating to therefore a smartphone-manufacturer) or an operating system of the mobile device 112.

If the verification or a part of this in Step 134 fails, this means that the URL 124 according to the assignment ID 122 is not intended for the verified user account and/or the mobile device 116 (but, e.g. for an account of another user and/or another mobile device). In such a case, the mobile device 112 terminates the further key assignment procedure.

In the case of a positive verification of the received assignment ID the mobile device 112 in Step 236 initiates the further continuation of the key assignment procedure. This may include, in Step 238, generating an endpoint for the assigned key 116 in the mobile device 112 and generating a certificate 126 therefor. This certificate 126 preferably comprises the assignment ID 122, e.g., in the form of a certificate extension. In Step 240 the further assignment procedure is carried out, e.g., a key tracking is initiated, etc.

As part of this assignment procedure, key tracking, etc., the mentioned certificate 126 with the assignment ID 124 in Step 268 (method 260 in FIG. 2C) accesses the server 104 in the vehicle-backend. The backend server 104 in Step 270 then checks a verification, i.e., checks the obtained assignment ID (likewise identified with the reference sign 132 in FIG. 1). In detail, here, an indication of a user account in accordance with the assignment ID contained in the certificate 132 is compared with an indication of a user account of the user 114, as it was stored in Step 264. The indication of a manufacturer in accordance with the assignment ID contained with the certificate 132 is stored with an indication of a manufacturer, as it was stored in Step 264. Additionally or alternatively, a device ID according to the assignment ID received with the certificate is compared with a device ID as stored in Step 264. In other embodiments only one or only two of the indicated checks are carried out.

If the verification of all or one part of this is unsuccessful this means that the URL was not called up under the intended user account according to the assignment ID and/or on the intended mobile device according to the assignment ID (but, e.g., was forwarded to another user account, another user and/or another mobile device. In such a case the vehicle-backend 104 forwards the further key assignment procedure.

If the verification is positive, the server 104 initiates the further progress in Step 272 up to finalization of the key assignment procedure, which comprises, e.g., persisting the assigned key 116 in the vehicle 102.

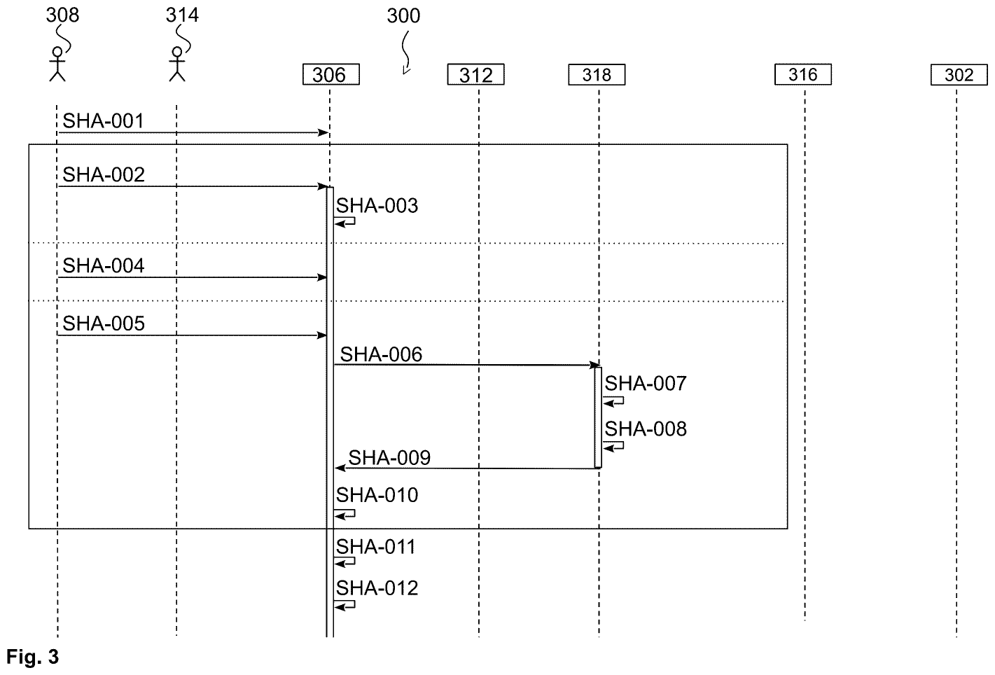

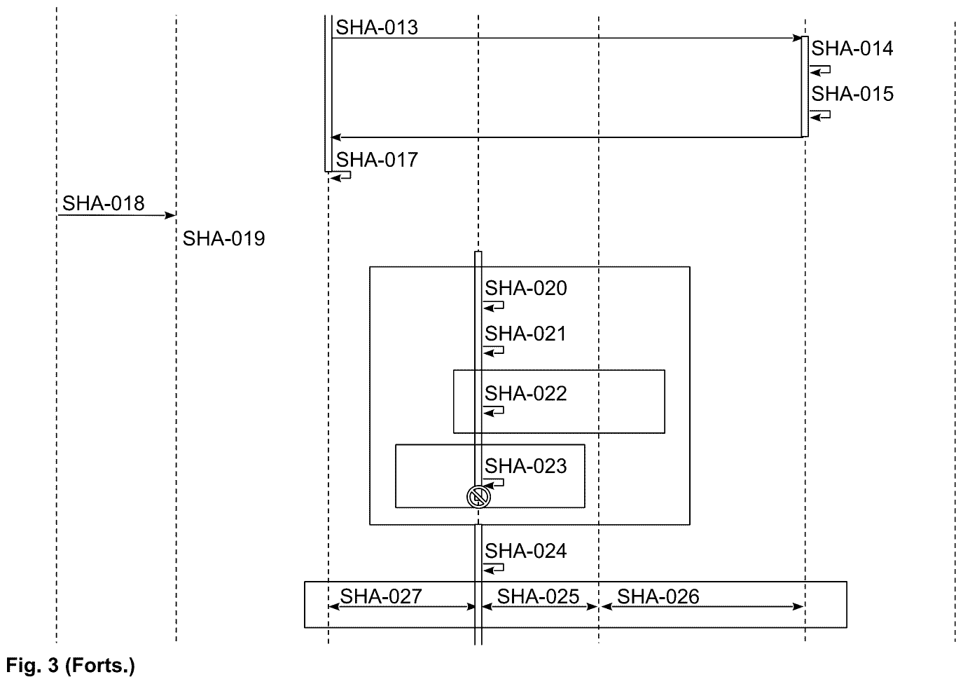

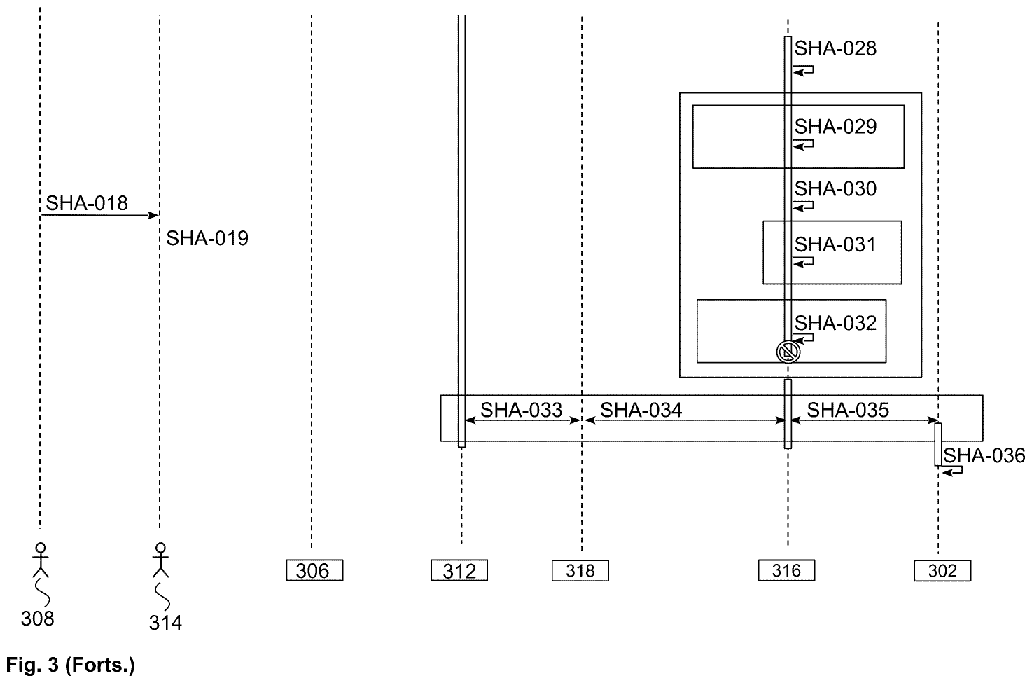

FIG. 3 illustrates in the form of a schematic sequence diagram a further embodiment of a method 300 for controlling access to a motor vehicle 302, wherein a backend 304 of the vehicle 302, a sharing mobile device 306, a user 308, a receiving mobile device 312 of a user 314, as well as a server 318 work together in a backend for the mobile device 312.

On the sharing mobile device 306 there is a digital vehicle key for the vehicle 302. The sharing user 308 would like to send the user 314 a derived key, wherein the mobile device 312 is intended for storing the derived key, e.g., from the issuing perspective, because the user 308 does not accept a storage on another device and/or from the receiving perspective, because while several devices are registered under one account of the user 314, but specifically the device 312 is intended for the carrying out of a service regarding the vehicle 302. The method 300 according to the invention ensures that the key to be assigned can only be activated if it is stored on the mobile device 312 provided for this purpose.

According to the method 300 the user 308 in Step SHA-001 solves a key assignment procedure, either directly on the mobile device 306 or through a backend server for the mobile device 306. In an embodiment the user 308 in Step SHA-002 selects a recipient for the key assignment. In Step SHA-003 the mobile device 306 can then provide an assignment ID for the selected recipient. For example, the assignment ID can already exist on the mobile device 306 (or in a backend).

In another embodiment the user 308, as indicated in Step SHA-004, can enter an assignment ID (e.g., by means of “Copy & Paste”).

In yet another embodiment the user 308, as indicated in Step SHA-005, a short ID can be entered (e.g., by means of “Copy & Paste”). In this case, the short ID must be resolved, i.e., the actual assignment ID must be determined. For this purpose, the mobile device 306 in Step SHA-006 sends an invitation, which contains the short ID and a vehicle ID of the vehicle 302, and which relates to the assignment ID, to the server 318 in the backend for the mobile device 312. This verifies the request in Step SHA-007 and determines an assignment ID from the short ID in Step SHA-008. In Step SHA-009, the server 318 returns the determined assignment ID. In Step SHA-010, the mobile device 306 provides the assignment ID received.

In an optional Step SHA-011 the mobile device 306 adds to the assignment ID if the assignment ID provided does not contain a manufacturer indication relating to the mobile device 312, add such an indication.

In Step SHA-012 information for the assignment security, which contains the assignment ID are placed together, encrypted, and signed. In Step SHA-013 a request which a sender-ID receives as well as the signed information on assignment security, is sent to the server 304 in the backend for the vehicle 302. The server 304 decrypts and verifies the signed information in Step SHA-014. In Step SHA-015, the information including the assignment ID is stored. In Step SHA-016, a response message relating to the successful saving is returned to the mobile device 306.

In Step SHA-017 the key assignment procedure including a relay server further prepared and a sharing URL is provided for the key parts. The URL encodes the assignment ID. In Step SHA-018 the sharing URL is given by the user 308 to the user 314. In Step SHA-019 the user 314 calls up the sharing URL on the receiving mobile device 312. The assignment ID is then verified on the mobile device 312.

In detail, the mobile device 312 in Step SHA-020 decodes the assignment ID. In Step SHA-021 the mobile device 312 verifies the assignment ID as against a user account, said more precisely, an account ID. If the assignment ID contains a device binding (“binding”), in Step SHA-022, the mobile device 312 verifies the assignment ID against the device ID, or more precisely, a device ID. If the assignment ID is not valid, the request for key sharing according to the sharing URL is ended at this point, i.e., in this case, in Step SHA-023, the receiving device 312 cancels the key assignment procedure.

However, if the verification was successful, a digital key is generated in Step SHA-024, and an endpoint (“endpoint certificate”) is issued for the digital key. In an embodiment the assignment ID is included as an expansion into the certificate, which is preferable from a safety perspective. In another example of an embodiment the endpoint certificate does not contain the assignment ID.

In Steps SHA-025, SHA-026, and SHA-027 the key assignment procedure runs between sharing mobile device 306, receiving mobile device 312, server 318 in the backend for the mobile device 312 and server 304 in the backend for the vehicle 302. Here, during key tracking, for example during a corresponding call from the server 318 to the server 304, in Step SHA-028, a certificate chain for the receiving mobile device 312 is verified by the server 304 in the backend for the vehicle 302.

The assignment ID received in Step SHA-013 before the start of the actual assignment process is then verified against the assignment ID, as it accessed the server 304 during the assignment procedure in Step SHA-026. In one embodiment, the allocation identifier is included as an extension in the endpoint certificate. In another embodiment, the assignment ID accesses the server 304 by means of the track key process.

The verification of the assignment ID comprises Step SHA-029, in which the server 304 verifies a passage of a device manufacturer ID; this comprises a corresponding comparison of the assignment ID contained in Step SHA-013 before the start of the actual assignment procedure with the assignment ID, how it accessed server 304 during the allocation process in Step SHA-026.

The verification of the assignment ID further comprises Step SHA-030, in which the server 304 verifies a passage of a user account, i.e. a corresponding identification or ID; this comprises a corresponding comparison of the assignment ID contained in Step SHA-013 before the start of the actual assignment procedure with the assignment ID, as it has accessed the server 304 during the assignment procedure in Step SHA-026.

If the assignment ID relates to a device binding, the verification of the assignment ID further comprises Step SHA-031, in which the server 304 verifies a match of a device ID or ID; this comprises a corresponding comparison of the assignment ID contained in Step SHA-013 before the start of the actual assignment procedure with the assignment ID, as it accessed the server 304 during the assignment procedure in Step SHA-026.

If it turns out that the assignment ID is not valid, the request for key sharing according to the sharing URL is terminated at this point, i.e. in this case the backend server 304 cancels the key assignment procedure in SHA-032 Step.

However, if the verification was successful, in Steps SHA-033, SHA-034 and SHA-035, the key assignment procedure is continued and finalized between receiving mobile device 312, server 318 in the backend for the mobile device 312, backend server 304 and vehicle 302. Here, the assigned key in the vehicle 302 persists in Step SHA-036.

Embodiments of the invention can ensure that a shared vehicle key derived from a digital vehicle key is or can only be activated if it is stored on an intended mobile device, i.e. a mobile device of an intended user, either a specific mobile device, depending on the application, or a mobile device that is assigned to an intended user account. Embodiments of the invention enable flexible adaptation of a binding (by assignment ID or URL) to a specific device or to a user account, depending on the use case. Additional security can be provided by a verification of a device manufacturer.

Embodiments of the invention can thus prevent misuse where a URL is forwarded for key assignment, e.g., from a designated mobile device to another device, without the knowledge or consent of the sharing user. The invention can therefore help increase the general confidence in the practicability and security of digital vehicle keys.

This applies to electronic key sharing procedures, which are important for business models such as garages, parking services, etc., especially with the increasing spread of digital vehicle keys.

Embodiments of the invention make it possible to dispense with multi-factor authentication, two-factor authentication, etc. by means of entry of a password, a PIN etc., in the case of certain uses, in which that is less practicable, e.g., in the garage area. This means that concepts for digital vehicle keys, key sharing etc. can be adapted more flexibly to different uses.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
102 Motor vehicle
104 Backend server for the vehicle 102
106 Sharing mobile device
108 Sharing user
110 Digital vehicle key
112 Receiving mobile device
114 Receiving user
116 Vehicle key to be assigned
118 Backend server for the mobile device 112
120 Short ID
122 Assignment ID
124 URL
126 Endpoint certificate
130, 132 Verification
200 Method
202 Receipt of the short ID
204 Sending a first request message
206 Receipt a response message
208 Sending a request message
210 Receipt of the response message
212 Initiating the key assignment
214 Generation of the URL
230 Method
232 Receipt of the URL 124
234 Verification
236 Initiating the further key assignment
238 Endpoint generation
240 Further assignment procedure
260 Method
262 Receipt of a request message
264 Storage of an assignment ID
266 Sending a response message
268 Receipt of a certificate
270 Verification
272 Further assignment procedure
300 Method
302 Motor vehicle
304 Backend server for the vehicle 304
306 Mobile device being shared
308 User being shared
312 Mobile device being received
314 User being received
318 Backend server for the mobile device 112

| | |
|---|---|
| SHA-001-SHA-011 | Provision of the assignment ID |
| SHA-012-SHA-016 | Storage of the assignment ID in the backend |
| SHA-017-SHA-019 | Generation and sending of the sharing URL |
| SHA-020-SHA-024 | Verification & generation of endpoint |
| SHA-025-SHA-027 | Assignment process |
| SHA-028-SHA-032 | Verification in the backend |
| SHA-033-SHA-036 | Finalization of the key assignment |

What is claimed is:

1. A method for controlling access to a motor vehicle, the method comprising:
receiving an assignment ID relating to a mobile device; and
initiating an assignment procedure of a shared vehicle key for a user of the motor vehicle based on the receiving assignment ID, wherein the shared vehicle key is derived from a digital vehicle key for the motor vehicle.

2. The method according to claim 1, wherein the receiving the assignment ID comprises:
receiving a short ID;
sending a first request message containing the short ID; and
receiving a first response message containing the assignment ID.

3. The method according to claim 1, wherein the assignment ID includes at least one of an indication of a user account of the user, a device ID relating to the mobile device and an indication of a manufacturer of the mobile device.

4. The method according to claim 2, wherein the assignment ID includes at least one of an indication of a user account of the user, a device ID relating to the mobile device and an indication of a manufacturer of the mobile device.

5. The method according to claim 1, further comprising:
sending a request message containing the assignment ID;
receiving a second response message relating to a receipt of the request message; and
initiating the assignment procedure based on the receipt of the second response message.

6. The method according to claim 2, further comprising:
sending a request message containing the assignment ID;
receiving a second response message relating to a receipt of the request message; and
initiating the assignment procedure based on the receipt of the second response message.

7. The method according to claim 1, wherein the initiating the assignment procedure includes providing an assignment reference, which represents the assignment ID.

8. The method according to claim 2, wherein the initiating the assignment procedure includes providing an assignment reference, which represents the assignment ID.

9. A method for controlling access to a motor vehicle, the method comprising:
receiving an assignment ID relating to a mobile device; and
verifying the assignment ID regarding at least one of an indication of a user account of a user, a device ID relating to the mobile device and an indication of a manufacturer of the mobile device.

10. The method according to claim 9, wherein the receiving of the assignment ID takes place as part of receiving an assignment reference, which represents the assignment ID, wherein the assignment reference relates to an assignment procedure of a shared vehicle key for the user of the motor vehicle, and wherein the shared vehicle key is derived from a digital vehicle key for the motor vehicle.

11. The method according to claim 9, further comprising:
after positively verifying the assignment ID, initiating the further assignment procedure.

12. The method according to claim 10, further comprising:
after positively verifying the assignment ID, initiating the further assignment procedure.

13. The method according to claim 11, wherein the initiation comprises:
generating an endpoint certificate relating to the shared vehicle key, wherein the certificate comprises an indication of the assignment ID.

14. A method for controlling access to a motor vehicle, the method comprising:
receiving a request message containing a first assignment ID relating to a mobile device;
sending a response message relating to a receipt of the request message; and
during an assignment procedure of a shared vehicle key for a user of the motor vehicle, wherein the shared vehicle key is derived from a digital vehicle key for the motor vehicle:
receiving a second assignment ID, and
checking the second assignment ID based on the first assignment ID.

15. The method according to claim 14, wherein the receiving of the second assignment ID takes place as part of receiving an endpoint certificate relating to the shared vehicle key, wherein the certificate comprises an indication of the second assignment ID.

16. The method according to claim 14, wherein the verifying relates to at least one of an indication of a user account of a user, a device ID relating to the mobile device and an indication of a manufacturer of the mobile device.

17. The method according to claim 15, wherein the verifying relates to at least one of an indication of a user account of a user, a device ID relating to the mobile device and an indication of a manufacturer of the mobile device.

18. A mobile device configured to control access to a motor vehicle according to claim 1.

19. A backend server configured to control access to a motor vehicle according to claim 14.

20. A system for controlling access to a motor vehicle, the system comprising:
the motor vehicle;
a first mobile device configured to receive an assignment ID relating to the first mobile device and initiate an assignment procedure of a shared vehicle key for a user of the motor vehicle based on the receiving assignment ID, wherein the shared vehicle key is derived from a digital vehicle key for the motor vehicle;
a second mobile device configured receive an assignment ID relating to the second mobile device and verify the assignment ID regarding at least one of an indication of a user account of a user, a device ID relating to the second mobile device and an indication of a manufacturer of the second mobile device; and
a backend server configured to control access to the motor vehicle according to claim 14.
